(19) United States
(12) Patent Application Publication
(10) Pub. No.: US 2019/0059324 A1
(43) Pub. Date: Feb. 28, 2019

(54) No Shed Doggie Shield

(71) Applicant: Courtney M. Kramer, San Jose, CA (US)

(72) Inventor: Courtney M. Kramer, San Jose, CA (US)

(21) Appl. No.: 15/480,329

(22) Filed: Aug. 28, 2017

(51) Int. Cl. A01K 13/00

(52) U.S. Cl. CPC A01K 13/006

(57) ABSTRACT

The No Shed Doggie Shield is a dog protection garment that 1) contains loose hair shed while wearing it, 2) provides the freedom for the dog to move without restriction while on and off a leash, and 3) keeps the dog safe from insect bites and scratches from foliage, without interfering with restraints available in the market. The garment folds to a compact size and can be stored inside a pouch or vehicle compartment when not in use.

### CROSS REFERENCE TO RELATED APPLICATIONS

There are no related applications to the No Shed Doggie Shield.

### FEDERALLY SPONSORED RESEARCH OR DEVELOPMENT

There is no Federally Sponsored Research or Development for the No Shed Doggie Shield.

### REFERENCE TO A SEQUENCE LISTING, A TABLE, OR A COMPUTER PROGRAM, LISTING COMPACT DISC APPENDIX

This does not apply.

### BACKGROUND OF THE INVENTION

Keeping dog hair off of furniture, carpeting and surfaces in your home and vehicle is a challenge. In addition, protecting dogs from burrs, ticks and other insects outside is also a challenge. The No Shed Doggie Shield was invented to address the issue of keeping my own dog's hair contained while we rode in the car. Current market solutions such as seat covers do protect seats from loose dog hair, but do not contain the hair from floating free inside the vehicle or home. Other solutions to contain the hair inside a vehicle or home, such as small crates and dog carriers, do keep the hair contained but do not allow the dog to be mobile inside the vehicle.

Outside in nature, dogs are at risk for dangerous bug bites and scratches from plants. Current market solutions include heavy, non-breathable full body suits made of heavy materials, which can put the dog at risk of overheating, or sprays and other chemicals that do repel insects, but do not protect the animal from scratches and burrs.

The No Shed Doggie Shield solves all of these challenges.

### BRIEF SUMMARY OF THE INVENTION

The No Shed Doggie Shield is a dog protection garment that 1) contains any loose hair shed while wearing it, 2) provides the freedom to move without restriction while on and off a leash, and 3) keeps the dog safe without interfering with the restraints available in the market.

### BRIEF DESCRIPTION OF THE SEVERAL VIEWS OF THE DRAWING

FIG. 1: On dog illustration

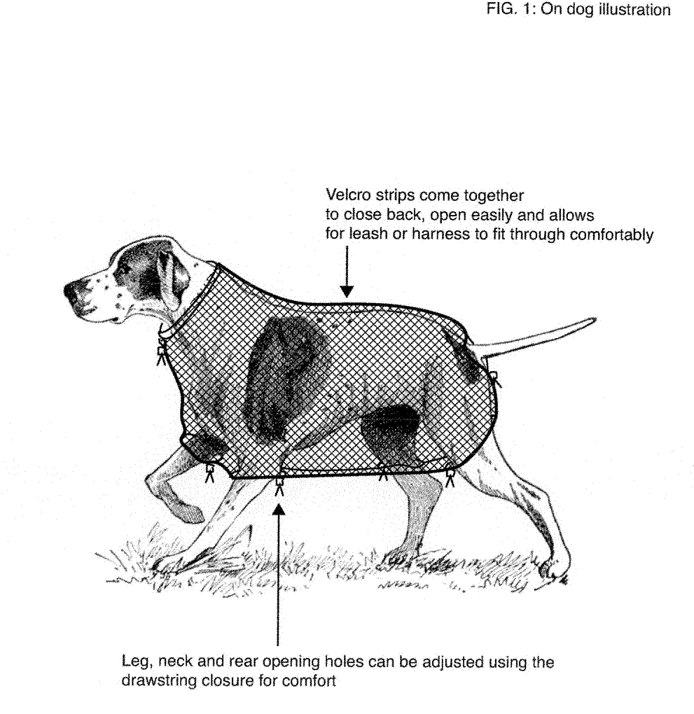

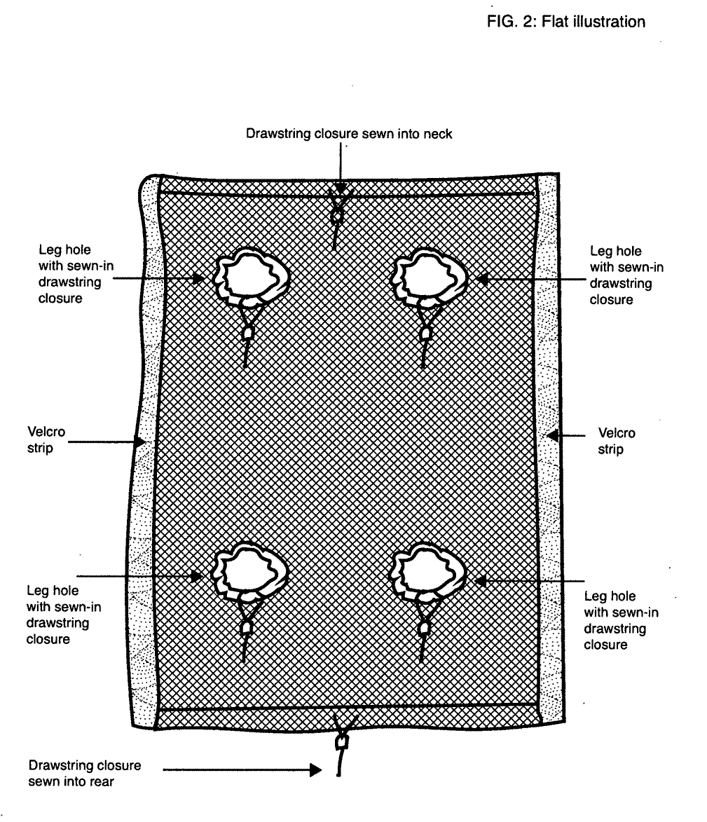

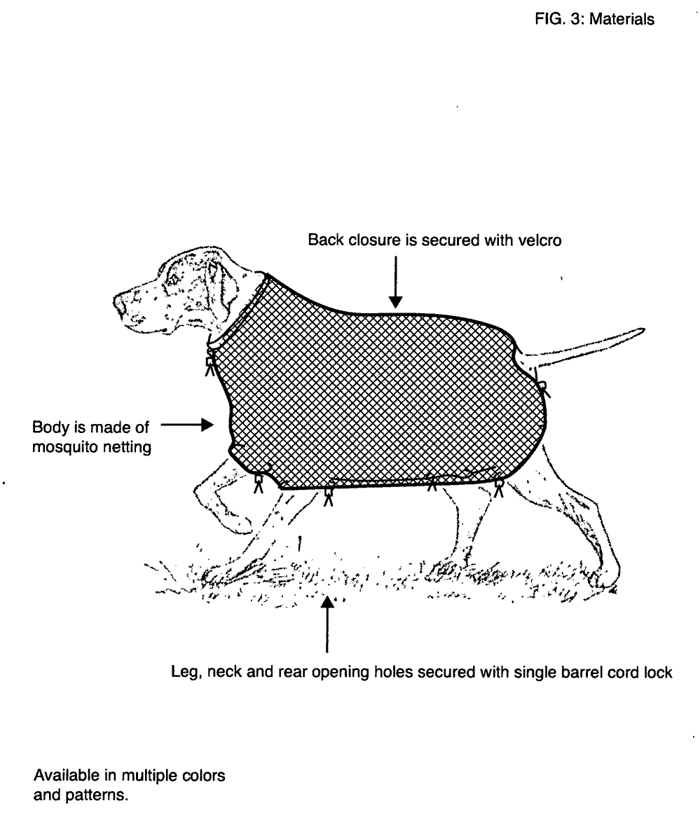

The Velcro-closure of the No Shed Doggie Shield down the back of the dog makes it easy for the owner to put it on and take it off the animal without struggle, and allows any style or restraint—collar leash, back harness, seatbelt harness, or stake lead—to fit properly without obstruction.

The drawstring closures around the dog's neck, tail and legs, provide the flexibility to adjust the tightness around each area, allowing it to accommodate the varying sizes of dogs.

The mosquito-netting is breathable, flexible, and provides proven protection against insect bites as well as contains loose hair shed by the dog.

FIG. 2: Flat illustration

Because the “off” state of the Shield lies flat and open, it is easy to put it onto a dog as it can stand over the Shield and it can be slipped up, threading their legs into the hole enclosures, then connecting the Velcro strips up the back to close the Shield around the animal.

The leg, neck and tail closures can then be adjusted for tightness.

FIG. 3: Materials

The mosquito-netting, nylon, cord and single barrel cord color will change, depending on its utility. For example, for a designer version of the Shield, the materials could be hot pink or a pattern, such as leopard print. For a hunting version, the materials could be neon orange, to enhance the dog's visibility in the brush. The original materials are black cords, closures and Velcro, and khaki green mosquito netting.

### DETAILED DESCRIPTION OF THE INVENTION

The No Shed Doggie Shield is a protective device for dogs in cars and homes against excessively-shed loose dog hair, and against insect bites, burrs and scratches from plants.

It is made by sewing together mosquito netting, Velcro, nylon, nylon cord and plastic single barrel cord locks. This is the best mode of assembly as envisioned by the inventor.

The Velcro strips are wide enough to stay closed down the dog's back while on the dog; sizes will vary based on size of Shield. The Velcro strips are sewn on either right and left side of the Shield, which wrap around and connect at the back of the dog.

The nylon cord is threaded through the nylon leg, neck and tail closures (which act as “tubes” where the cord is contained but has the freedom to move freely through the tube), and the ends of equal size emerge from each side opening of the closure, held by the single barrel cord lock. The single barrel cord lock is adjustable up and down the ends of the cord, which adjusts sizing. On the neck and tail sides of the Shield, the cord end is sewn into the nylon closure at the Velcro side and emerges at the base of the neck and under tail for adjustment.

The tail may be tucked inside the Shield, or worn outside of the adjusting cord. The neck enclosure can be worn behind the ears, enclosed around the neck, or over the ears enclosed around the face, depending on the comfort of the dog. The placement of the closures around the legs may be adjusted, depending on how exposed the human user wants the dog's legs.

Currently, there is no known product using this design, or materials to create an easy to wear, flexible and safe dog product.

The flexible nature of the material allows it to be folded into a compact, pocket-sized dog garment, which could easily fit inside a nylon case and attached to a dog leash or fit inside a car compartment.

1. I claim a worn dog protection garment including the functions of containing shed hair when worn and added safety from bug bites and plant scratches.

2. I claim a dog protection garment that is worn by the dog and keeps loose shed hair inside the garment when worn.

3. I claim a dog protection garment that is manufactured using mosquito netting and is worn by the dog.
